(19) United States
(12) Patent Application Publication
(10) Pub. No.: US 2014/0300027 A1
(43) Pub. Date: Oct. 9, 2014

(54) SYSTEMS AND METHODS FOR APPLYING A BRAID TO AN IRREGULAR CORE

(71) Applicant: A&P Technology, Inc., Cincinnati, OH (US)

(72) Inventors: Andrew A. Head, Cincinnati, OH (US); Steven Charles Stenard, Cincinnati, OH (US)

(21) Appl. No.: 14/210,932

(22) Filed: Mar. 14, 2014

Related U.S. Application Data
(60) Provisional application No. 61/789,126, filed on Mar. 15, 2013.

(51) Int. Cl. B29C 63/22

(52) U.S. Cl. CPC B29C 63/22
USPC 264/138; 264/310; 425/365

(57) ABSTRACT

Various methods (1000, 1100) can be employed to apply a braided product to an irregular core. Application can occur while preserving the integrity of the braided structure. A system (200) can be designed in turn to apply a braided product to an irregular core (212). The system can include a mandrel (206) that prevents distortion of the braid during application. System (200) can additionally include a pinch clamp (210) and cam track assembly (214) that are designed based at least in part on the irregular core (212). Further, a mandrel (100) can be designed to prevent distortion of braiding of a braided structure by maintaining constant length in all directions.

This application claims the benefit of U.S. provisional patent application 61/789,126, filed Mar. 15, 2013 and which is hereby incorporated herein by reference.

### TECHNICAL FIELD

The present invention relates to a systems and methods for applying a braided material to an irregular-shaped mandrel.

### BACKGROUND OF THE INVENTION

Braided materials are used in many applications and environments, and are used in the construction of composite structures for a variety of functional and aesthetic designs. Braided fibers are continuous and can interlock mechanically, and accordingly distribute loads throughout a braid architecture. A variety of fiber materials and braiding techniques are used to suit particular applications. However, the handling needs of various braided, woven, non-woven, and other materials can vary. For example, handling and applying a biaxially braided structure including cotton fiber can be different from handling and applying a triaxially braided structure including polymer fiber. Further, braided structures are subject to braid distortion or deformation when manipulated, in particular after the braid has been produced, in its collection, modification, storage and transportation.

Braided materials have been applied in layers or sleeves over mandrels, cores, or other materials in the production of composite structures. Prior processes for covering or otherwise applying a braided material to a core have been prone to braid distortion when improperly applied.

Shaping mandrels have been used to affect or assist shape transitions of braided materials over mandrels or cores. Prior solutions have caused local distortion or disruption of the braid. Further, irregularly shaped cores have caused additional challenges when the transition from a regular braid shape to irregular geometry has not been accommodated.

### BRIEF SUMMARY OF THE INVENTION

The following presents a simplified summary of the innovation to provide a basic understanding of the innovation. This summary is not intended to identify all of the elements of the innovation but to present some concepts of the innovation in a simplified form as a prelude to further description presented below.

Disclosed is a method for applying a prefabricated braided product to an irregular (e.g., irregularly-shaped, asymmetrical, and others) core, comprising receiving the braided product from a source, transitioning or sizing the braided product over a mandrel between the source and the irregular core, securing the braided product to a clamp at least partially surrounding the irregular core, and conveying the clamp along a path to move the braided product over the irregular core, wherein the path is based on a geometric aspect of the irregular core.

Also disclosed is a system for applying a prefabricated braided product to an irregular core, comprising a mandrel that transitions the prefabricated braided product, a clamp that secures the prefabricated braided product and at least partially surrounds the irregular core, and a cam track assembly based at least in part on a geometric aspect of the irregular core.

A mandrel may be used for reshaping a state of a braided article. The mandrel may be adapted to maintain equal tow lengths of the braided article in one or more directions as the braid passes over the mandrel during application of the braid to a core (including an irregular core). Mandrels can, but need not, include at least one developable surface.

Certain illustrative elements of the present innovation are described herein in connection with the following description and the annexed drawings. This description is indicative, however, of but a few of the various ways in which the principles of the innovation can be employed. The subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIGS. 1A, 1B and 1C are side, top, and bottom views respectively of an example of a mandrel of the present disclosure.

FIG. 2 is a perspective view generally illustrating an example of a system of the present disclosure for applying a braid to an irregular core.

FIGS. 3A and 3B generally illustrate a portion of the system of FIG. 2 for applying a braid to an irregular core showing a portion of a guide roller assembly.

FIGS. 4A and 4B generally illustrate a portion of the system of FIG. 2 including the mandrel shown in FIGS. 1A-1C.

FIGS. 5A and 5B are additional views of the mandrel installation of FIGS. 4A and 4B.

FIGS. 6A and 6B generally illustrate a portion of the system of FIG. 2 for applying a braid to an irregular core showing an irregular-shaped core and a pinch clamp.

FIGS. 7A and 7B generally illustrate a portion of the system of FIG. 2 showing a cam track assembly.

FIGS. 8A, 8B, and 8C are top, side, and perspective views respectively generally illustrating a portion of the system of FIG. 2 including a roller assembly.

FIGS. 9A and 9B are additional views of the roller assembly shown in FIGS. 8A-8C.

FIG. 10 is a flowchart of an example methodology for applying a braid to an irregular core.

FIG. 11 is a flowchart of an alternative methodology for applying a braid to an irregular core of particular dimensions.

### DETAILED DESCRIPTION

Braids (e.g., biaxial, triaxial, and others) can be formed on circular braiding machines and are frequently produced in tubular form. After production, the braids are stored, for example, on a spool. Braids can thereafter be applied to a variety of products to provide additional support or structural qualities as desired. For certain applications, one or more layers of braid is applied over a shaped core and then impregnated with resin to form a composite structure. It is typically desired to provide the braid over the core with a minimum of unintended fiber displacement or distortion to maintain a desired strength in the finished product. Particularly when the core has an irregular shape, we have found that to prevent distortion or disruption of the braid structure during handling or application, the braided product can be transitioned over one or more intervening surfaces on a mandrel according to particular geometries to maintain constant lengths of the tows (e.g., axial, biaxial, and others), and then guided over the irregular shaped core by moving the braid along a predetermined path applying the braided product over the irregular core, the path corresponding to a geometric aspect of the irregular core. Thus, a mandrel (or other forms) as disclosed can be used to transition a portion of braided reinforcing fibers to a modified form in preparation for manipulation or application of the braid. “Transitioning” can generally refer to moving a braid over a surface (e.g., 2-dimensional, 3-dimensional) in a way that modifies (e.g., expands a tubular braid from a flattened state) or maintains (e.g., keeps equal tow lengths to avoid distortion) the braid's shape or configuration. Similarly, “sizing” a braided product over an object (e.g., a mandrel, a core, and others) can include fitting the braided product over the object, and particularly, fitting the braided product over the object in a way that does not distort the braided pattern. Various other terminology can be used to refer to maintaining a constant cross-sectional perimeter size (e.g., shape changes but perimeter length remains constant) and/or maintaining a constant tow length.

Various systems and methods can be employed to apply a braided product to an irregular core. In certain embodiments, an irregular core is a work piece to which a braid can be applied having at least one asymmetrical dimension or portion of geometry. For example, a propeller blade can be made using an asymmetrical irregularly shaped core, which includes curvature about multiple axes, tapered edges, varying cross-sectional dimensions, and a semi-symmetrical portion at which it can be attached for use. Systems and methods can be designed to apply prefabricated braided products (e.g., tubular braided composites) to asymmetrical or symmetrical irregularly shaped work pieces or cores inhibiting distortion of the braid structure during application. Additionally, the presently disclosed methods and apparatus may be used to apply braid to regular or uniformly shaped work pieces or cores.

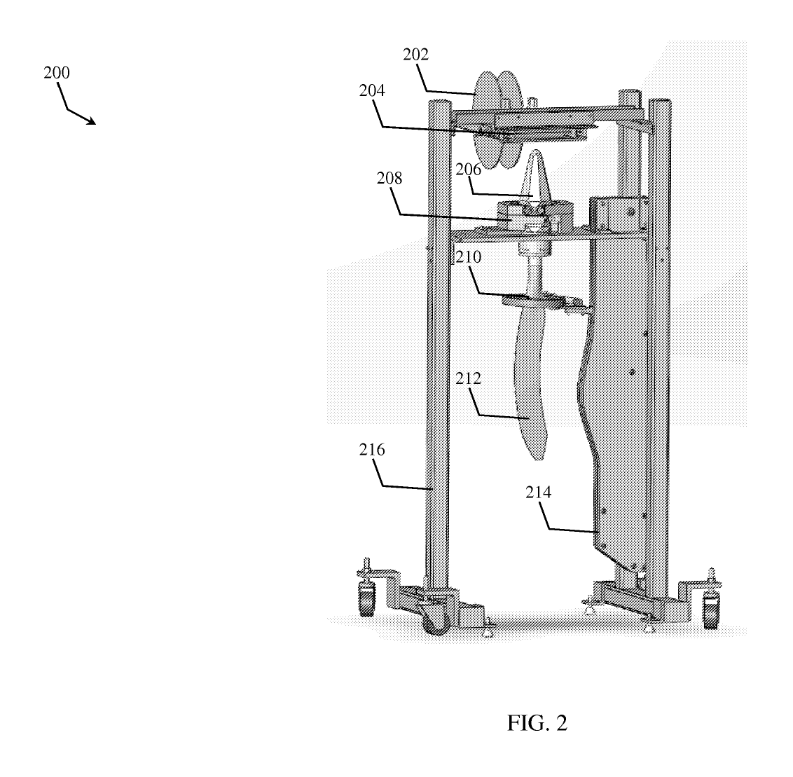

FIG. 2 illustrates an apparatus 200 for applying a continuous length of braid to an irregular shaped core 212. The apparatus includes a mandrel 206 corresponding to a desired braid size positioned between a braid source 202 and the irregular core 212. A cam track 214 is provided along a path corresponding to a geometric aspect of the irregular core, and a clamp 210 at least partially surrounding the core is movable along the cam track. The clamp is operatively securable to a portion of the braided product and pulls the braid over the mandrel and over the irregularly-shaped core. In one example, braid is applied to the core 212 by receiving braided product from a source such as directly from a braiding machine or from a spool 202; sizing the braided product over the mandrel 206 positioned between the source and the irregular core 212; securing the braided product to the clamp 210 at least partially surrounding the irregular core; and moving the clamp along a predetermined path 214 applying the braided product over the irregular core, where the path corresponds to a geometric aspect of the irregular core. For certain applications, the tow length and tension in the tows is kept approximately constant in all directions to avoid braid distortions as the braid moves over the mandrel.

In the embodiment of FIG. 2, the mandrel is supported by engaging a plurality of rollers, further discussed below, where the braid passes between the mandrel and the supporting rollers. The mandrel is shaped to maintain equal tow lengths of the braided article in one or more directions as the braid passes between the mandrel and the supporting rollers during application to a core (including an irregular core). The mandrel includes a mandrel body that may employ indentations or recesses designed to interface with the plurality of rollers supporting the mandrel. In certain embodiments, the mandrel body can include one or more developable surfaces.

To prevent distortion or disruption of the braided material passing beneath the support rollers, the shaping mandrel includes, at least in part, a series of transitional surfaces between predetermined cross-sections. Where the mandrel is supported by the plurality of support rollers, the distance around the perimeter of each of the various cross-sections remains approximately the same. The transitional surfaces (including developable surfaces or portions thereof, where included) maintain constant lengths of the tows (e.g., axial or biaxial fibers, yarns, et cetera) as the braid passes between the mandrel and the supporting rollers during application to irregular cores.

The present apparatus and method as disclosed may be used with braids, braided structures, braided architecture, plaits, and similar materials or structures. In addition, weaves, woven structures, woven architecture, and similar materials or structures. At times, braided or woven structures to be processed can be referred to simply as “material” or “materials.” Unless expressly noted otherwise, nothing herein should be read to exclude use of any type of braid (e.g., biaxial, triaxial, various others), weave, composite architecture, fiber combining, or similar items. Various proprietary braids or weaves, various braid or weave angles or materials (including two or more tow material types), over-braided designs, fillet designs, curved designs, and other non-uniform or hybrid architecture are intended to fall within the scope of the disclosures herein. Generally, braided, woven, or other composite structures that are prefabricated for later application to cores for the purpose of the present disclosure are “braided products.” Braided products can (but need not always) be continuous (e.g., formed or stored in amounts larger than required for single application) and/or tubular (e.g., annular shape, asymmetrical hollow shape).

As used in the present specification and claims, tows can include one or more fibers, strands, yarns, strings, or other composite subcomponents used in a braid or weave. A tow can be an individual component of a braid. In addition, a smaller braid can be a tow for a larger braid. Put another way, tows can include subordinate tows, or be a portion of superior tows. All tows within a braid or weave need not be identical, and different tows can be of different material or aesthetic nature within the same braid or weave.

As used in the present specification and claims, references to a developable surface can be surfaces facilitating constant tow length in all directions. Mathematically, a developable surface is a surface with zero Gaussian curvature that can be flattened into a plane with no distortion such as stretching or compressing. A developable surface can be made by transforming a plane. In some aspects, origami provides an apt analogy for the developable surface, as a single piece of paper can be modified to produce a pattern or structure. Portions of developable surfaces can be used, and in embodiments, mandrels or other portions herein need not employ developable surfaces. Additionally, the concept of a developable surface can facilitate understanding of the present mandrel surfaces without actually employing a mathematically true developable surface.

As used herein, spatially orienting terms such as “above,” “below,” “upper,” “lower,” “inner,” “outer,” “right,” “left,” “vertical,” “horizontal,” et cetera, can refer to respective positions of aspects as shown in the accompanying drawings. Such terms are employed for purposes of clarity in describing the drawings, and should not be construed as exclusive, exhaustive, or otherwise limiting with regard to position, orientation, perspective, configuration, and so forth.

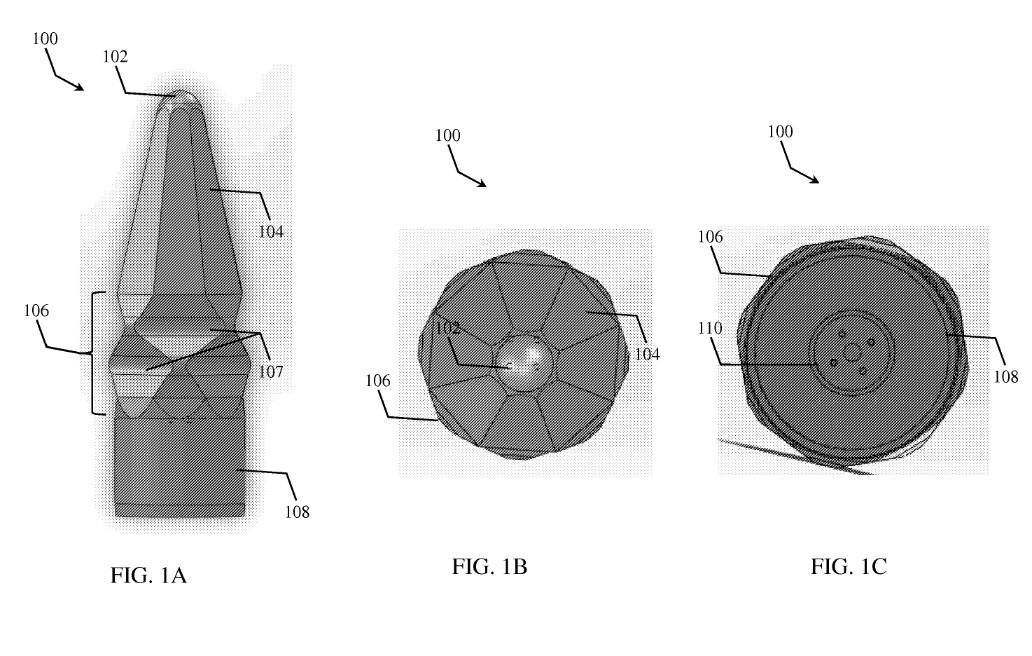

Referring now to FIGS. 1A, 1B and 1C, the mandrel 100 is designed, at least in part, to calibrate the circumferential size and shape of the braid while preventing distortion of the braid by maintaining constant tow length in all directions as the braid moves over the mandrel. The mandrel 100 typically is of varying cross-section, and in certain embodiments the mandrel 100 has adjacent cross-sectional portions that maintain a constant cross-section perimeter length despite having different shapes. In particular embodiments, a developable surface or portion thereof can be used in the design of mandrel 100.

In the embodiment shown in FIG. 1A, the mandrel 100 is a tapered mandrel used upstream from an irregular core on which a pre-fabricated braided composite is applied. As shown in FIG. 1A, the mandrel 100 may include a tip 102, diverging facets 104, a suspension portion 106, a base 108, and an interface 110 in embodiments. The mandrel 100, or portions thereof, can be polished, plated, or provided with a desired coating to assist the braid passing over the mandrel or withstand environmental conditions.

The tip 102 begins at the top of the mandrel where a braided composite can be received (e.g., from a spool). As pictured, the tip 102 can be a hemispherical surface. The tip 102 may take various other shapes without departing from the spirit or scope of the disclosures herein. For example, other curved geometries can be employed (e.g., partial ellipsoid). In another example, flat-surface geometries (e.g. pyramidal) can be employed in the construction or geometry of tip 102.

The tip 102 can be a continuous part of, connected to, or transition to the diverging facets 104. Upon contact with the mandrel 100, a tubular (e.g., need not be cylindrical) braided member passes over the tip 102 to the diverging facets 104 where the braided member is opened and guided along the mandrel. As illustrated in FIGS. 1A and 1B, diverging facets 104 can include a plurality of flat sides that diverge in two dimensions traveling from tip 102 toward base 108 along an axial direction. Thus, if the axial direction is regarded as the length of mandrel 100, the portion of diverging facets 104 can be symmetrically wider and deeper at a portion closer to base 108. As illustrated in FIG. 1, diverging facets 104 can include eight symmetrical sides. However, various other geometries (e.g., six symmetrical sides, twelve symmetrical sides, rounded conical shape, asymmetrical sides) can be used in alternative or complementary embodiments without departing from the spirit or scope of the disclosures herein.

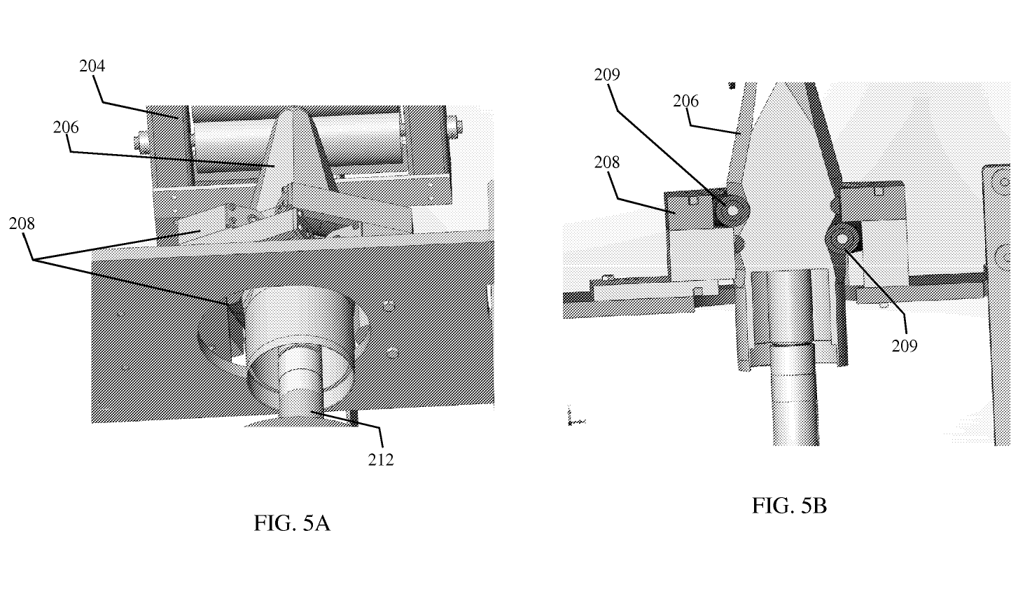

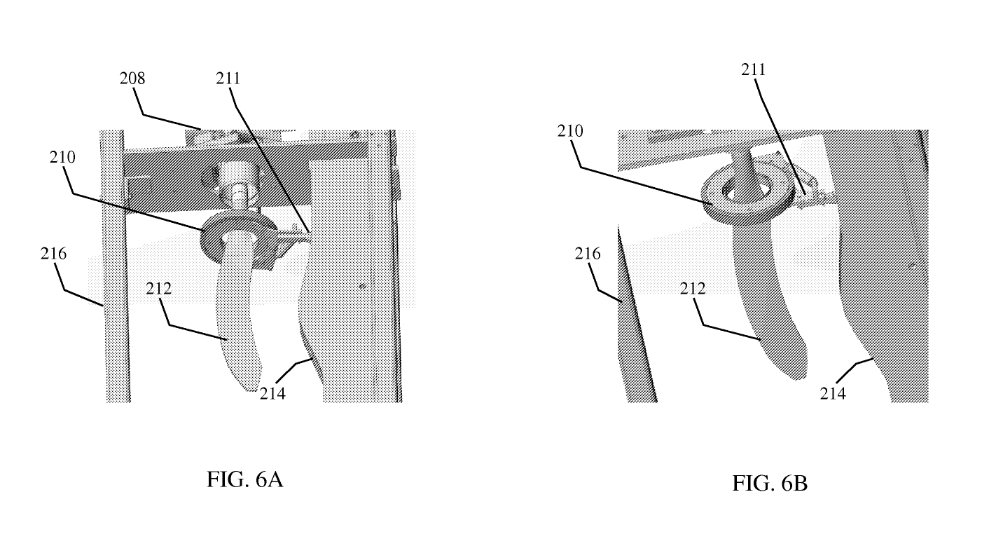

After passing diverging facets 104, a tubular braided member reaches a bearing portion or suspension portion 106 having a plurality of bearing surfaces adapted to support the mandrel on a plurality of support rollers further discussed below with respect to FIGS. 5 and 6. Optionally, the suspension portion 106 may include one or more developable surface. The bearing surfaces of the suspension portion 106 may form roller recesses or indentations 107 facilitating support of the mandrel 100 by roller assemblies discussed below. For purposes of simplicity, not all roller indentations 107 are visible or labeled. The geometry of the suspension portion 106 ensures that a braided member passing between the bearing surfaces and the support rollers maintains constant tow lengths in all direction, inhibiting distortion of the braid. The suspension portion 106, alone or in combination with other aspects of the mandrel 100, can be a bearing surface.

The mandrel 100 includes the base 108, which as illustrated in at least FIGS. 1A and 1C, can be a cylindrical portion. However, in various alternatives other geometries (e.g., polygonal cross-section) can be used. The base 108 includes interface 110 used to connect the mandrel 100 to the core or other work piece or components in which the mandrel 100 can be integrated.

FIG. 2 generally illustrates an example of the system 200 for applying a braid to the irregular core 212. The system 200 can include the spool 202, or may be in-line with a braiding machine supplying a continuous braid to the system. Also shown are the spool guide 204, mandrel 206, roller assembly 208, pinch clamp 210, cam track assembly 214, and modular frame 216. In the embodiment shown in FIG. 2, the irregular core 212 is a core for use in the manufacture of a propeller for aeronautical applications. However, any number of core shapes and sizes may be used, and the particular shape, use, and/or nature of irregular core 212 shown does not limit the innovation.

The modular frame 216 connects and supports the components of the system 200. The modular frame 216 can be a self-contained apparatus, and can facilitate movement or installation of system 200 as a single-step job. In embodiments, modular frame 216 can include wheels, brakes, and/or feet to ease movement and/or placing of system 200.

The spool 202 can be located at the top of modular frame 216. The spool 202 can be a spool that retains a braided product or receives a retainer for braided product to be applied to the irregular core 212. The spool 202 rotates in a direction unspooling the braided product toward the spool guide 204. In various embodiments, the spool 202 can include a powered component that drives the spool to wind or unwind the braided product. In embodiments, the spool guide 204 can include at least a rolling portion that can direct the braided product to mandrel 206 after the braided product is unwound for application to irregular core 212. In alternative or complementary embodiments, spool guide 204 can include a fixed guide (e.g., U-shaped channel).

Following the spool guide 204, the braided product passes over the mandrel 206, where it is secured to a clamp 210 at least partially surrounding the irregular core 212. The pinch clamp 210 clamps the braided product and pulls the braid over the mandrel 206 and over the irregular core 212. The pinch clamp 210 guides the braided product over irregular core 212 by the travelling cam track assembly 214. For various applications, the pinch clamp 210 can be exchanged for different sizes, shapes and/or configurations to accommodate different types, sizes, and shapes of irregular core 212. The pinch clamp 210 (and accompanying structural aspects) can be arranged in a quick-detach fashion whereby no tools are required to remove or install the pinch clamp 210. For example, various pins, clamps, latches, hooks, et cetera can be employed to retain the pinch clamp 210. In other embodiments, tools or other equipment (e.g., drivers, punches, wrenches, screws) can be used to remove or install variants of the pinch clamp 210.

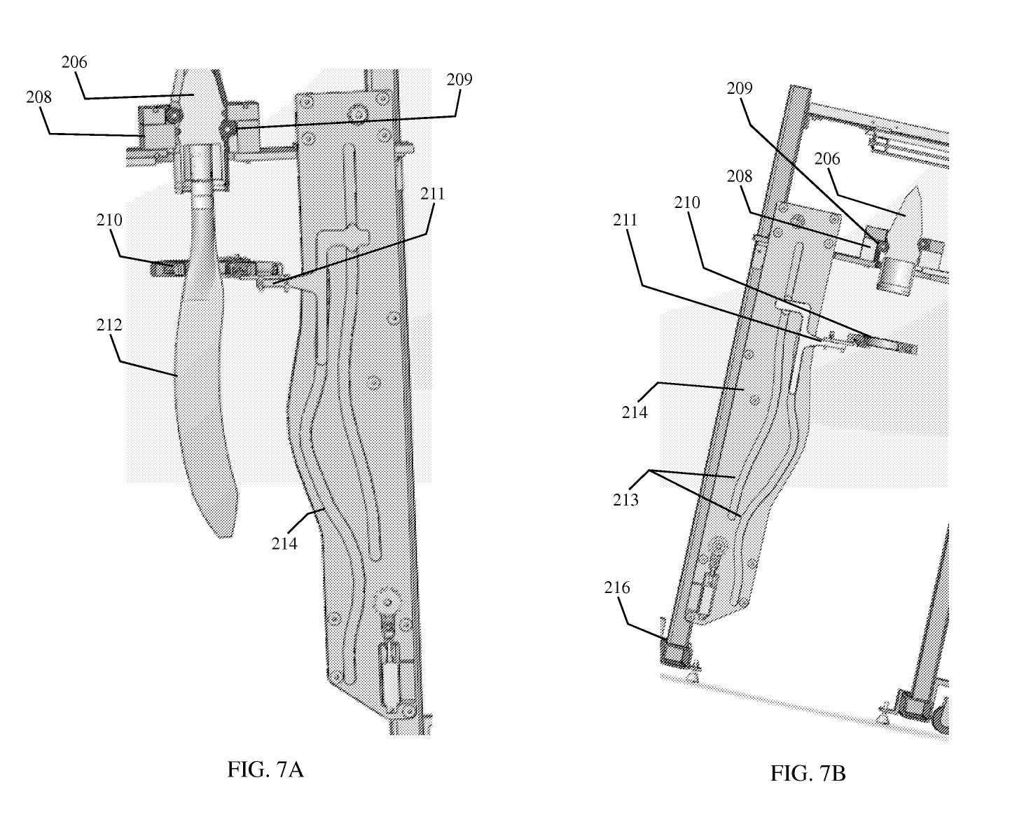

The pinch clamp 210 is operatively coupled with the cam track assembly 214 to facilitate at least two-dimensional motion based on one or more geometric aspects related to or corresponding to the irregular core 212, such as height, width, length, curvature, and so forth. For example, as shown in FIG. 7, the cam track assembly may provide motion along a predetermined path corresponding to a particular curvature along the irregular core. In certain embodiments, the cam track assembly 214 can facilitate three-dimensional motion of the pinch clamp 210. In certain embodiments, the cam track assembly 214 can facilitate rotation of the pinch clamp 210 about one or more axes.

In various embodiments, the cam track assembly 214 can be interchangeable to facilitate varying geometries. For example, the system 200 can be set up to apply the braided product to a core for manufacturing a propeller blade, and later be switched to apply braided product to sports equipment or a prosthesis. One or more geometric aspects (e.g., height, width, length, curvature, and so forth) can vary between these work pieces. In embodiments, system 200 can be configured to exchange different versions or types of cam track assembly 214 to accommodate a different irregular core 212. The cam track assembly 214 (and accompanying structural aspects) can be arranged in a quick-detach fashion whereby no tools are required to remove or install variants of cam track assembly 214. For example, various pins, clamps, latches, hooks, et cetera can be employed to retain cam track assembly 214. In other embodiments, tools or other equipment (e.g., drivers, punches, wrenches, screws) can be required to remove or install cam track assembly 214.

In embodiments where the cam track assembly 214 can be swapped, the modular frame 216 can be configured to facilitate varying geometry as well. For example, portions of modular frame 216 can be configured to telescope, pivot, open, close, et cetera to ensure work pieces of varying height, width, depth, and curvature can be accommodated for use as the irregular core 212. The modular frame 216 may be designed around maximum and minimum sizes of irregular cores 212, and be adapted to accommodate set-ups within the maximum and minimum size constraints as modular component sets. In certain embodiments, the modular frame 216 can include multiple component sets that can be exchanged to accommodate varying sizes of irregular core 212. For example, various beams or spacers can be installed or exchanged with modular frame 216 to modify its dimensions for different sizes of irregular core 212.

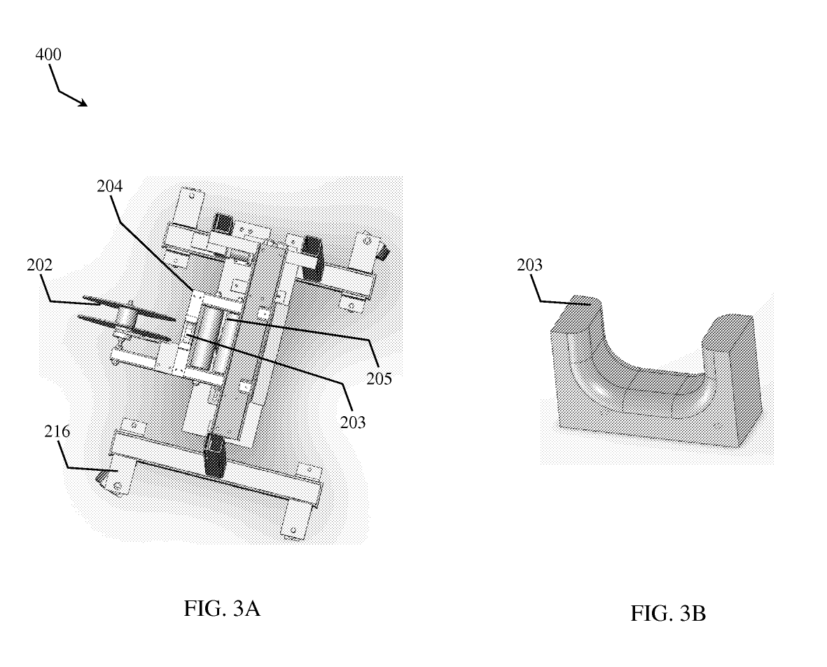

Turning now to FIGS. 3A, and 3B, the spool 202 and spool guide 204 are shown from an overhead perspective. The spool 202 can unwind a braided product to the spool guide 204 to direct the braided product through the system 200. In the embodiment shown in FIG. 3A, the spool guide 204 includes the channel guide 203 and guide rollers 205. As the braided product is received from spool 202, the braided product can be received through the channel guide 203 to the guide rollers 205, which can direct the braided product down toward the mandrel 206 (not pictured in FIG. 3A or 3B). In certain embodiments, the guide rollers 205 can include a powered component that drives the spool to wind or unwind the braided product. The spool or spool guide may include a tensioner providing a desired load or tension in the braid by maintaining a predetermined tension in a direction away from the movement of the pinch clamp.

As illustrated in FIGS. 3A and 3B, the channel guide 203 can be of a U-shaped configuration. However, in various embodiments of the system 200, the channel guide 203 can be of different geometry, such as a ring, notch, square, et cetera. In addition, the guide rollers 205 are shown as two rollers, but alternative or complementary embodiments can have more or fewer rollers. While the embodiment of the spool guide 204 illustrated in FIGS. 3A and 3B can be used with the system 200, it should not be perceived as the only means for effecting the same result, and the system 200 need not include one or more aspects of the spool or spool guide illustrated here or elsewhere.

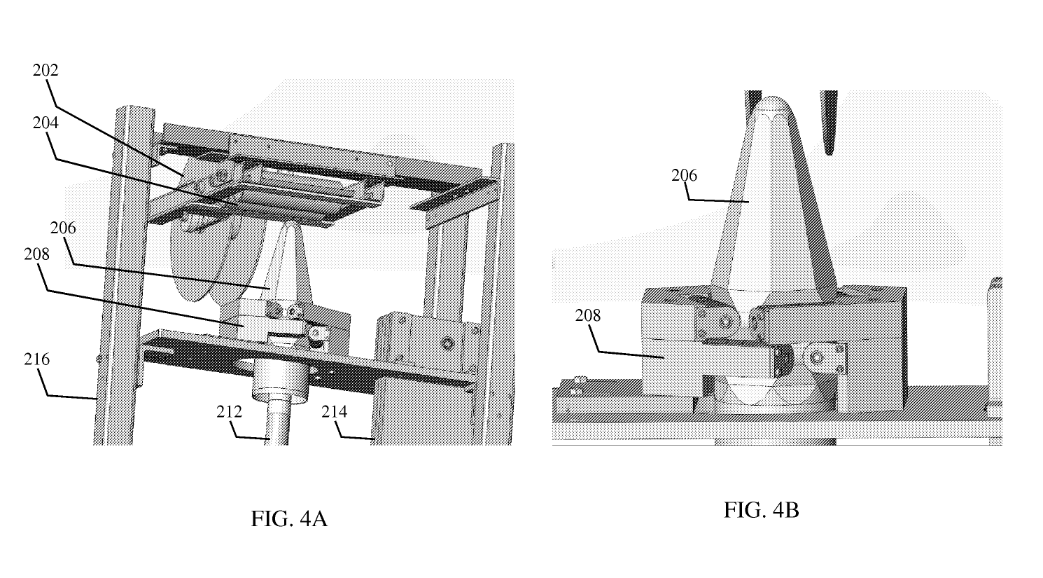

As shown in FIGS. 4A and 4B, the mandrel 206 is positioned beneath the spool guide 204 to receive the braided product from the spool guide. The braided product passes over the mandrel and between the mandrel 206 and the roller assembly 208. As discussed above, the roller assembly 208 supports the mandrel in a desired position by bearing surfaces on the mandrel engaging corresponding support rollers 209 of the roller assembly as shown in FIG. 5B. The support rollers 209 of the roller assembly 208 may be positioned such that the roller assembly includes open portions (e.g., as-pictured with gaps between rollers not fully surrounding mandrel 206). In alternative embodiments, the rollers of the roller assembly 208 are positioned forming a closed assembly (e.g., fully surrounding mandrel 206 with a housing that closes gaps between rollers). As shown in the figures, the system may be configured such that the roller assembly 208 suspends the mandrel 206 and attached core 212 in place, and no further support is provided to the mandrel 206 or core.

As shown in FIGS. 5A and 5B, the core is attached to the base of the mandrel 206 and supported by the mandrel. As discussed above and shown in FIG. 5B, the support rollers 209 align with recesses or indentations in the mandrel 206 to suspend or otherwise support the mandrel 206 and core 212. In embodiments, the support rollers 209 exclusively support the mandrel, which does not contact other portions of system 200.

In the embodiment of FIGS. 6A and 6B, the pinch clamp 210 encircles the core 212. The pinch clamp 210 is adapted to clamp the braided product and pull the braided product over the irregular core 212. The pinch clamp 210 can travel the length of the cam track assembly 214 at least to the end of the irregular core 212. Pinch clamp 210 is operatively coupled with the cam track assembly 214 using, for example, the clamp arm 211. In certain embodiments, the pinch clamp 210 is used to pull multiple layers of the braided product over the irregular core 212. For example, after the pinch clamp pulls one layer of braid the length of the core, the braided product can be cut at a desired location generally between the mandrel and the core, whereby the pinch clamp 210 returns to the top of the cam track assembly 214 and re-clamps to the cut end of the braided product extending from the mandrel. In an alternative example, the pinch clamp and cam track assembly 214 can fold or connect the braided product at a particular point to facilitate folding of the braided product to apply a subsequent layer, before cutting of the braid away from the mandrel or after.

The pinch clamp 210 can be operatively coupled to a powered component (e.g., a chain drive, cable drive, gear drive, rack and pinion, linear actuator, pneumatic or hydraulic actuator, et cetera) adapted to move the pinch clamp 210 along the cam track assembly over or around irregular core 212. In one or more embodiments, pinch clamp 210 is the only element exerting an active force on the braided product. In such embodiments, spool 202, guide rollers 205, mandrel rollers 209, and other movable portions of system 200 can be wholly passive and/or unpowered, and transmit no force to the braided product passing over the irregular core 212 or other portions. Various hybrid approaches or alternatives to powering the system 200 can be appreciated in view of the disclosures herein.

In embodiments, the pinch clamp 210 can be exchanged to accommodate different types, sizes, and shapes of irregular core 212 with varying geometry. In alternative or complementary embodiments, the pinch clamp 210 can be reconfigurable to accommodate at least one irregular core 212. For example, while the pinch clamp 210 is shown as a solid ring, embodiments can include various horseshoe or open shapes, arms, hinges, connections, et cetera, of pinch clamp 210 to facilitate changing of the shape or orientation of a single pinch clamp 210 for one or more applications.

As shown in FIGS. 7A and 7B, the cam track assembly 214 can include tracks 213 that can guide at least a portion of the clamp arm 211. The tracks 213 define at least one path travelled by the pinch clamp 210 and/or clamp arm 211. FIGS. 7A and 7B display a cutaway view of cam track assembly 214 showing the tracks 213 that are not visible during operation, as tracks 213 are enclosed within the cam track assembly 214 when fully assembled. In alternative or complementary embodiments, at least a portion of the tracks 213 (and/or portions of clamp arm 211 not protruding beyond a housing of cam track assembly 214) are visible during operation, and having no housing completely surrounding these portions (e.g., clamp arm 211 nests behind a flange in a channel of tracks 213 such that clamp arm 211 can be supported without a closed housing covering opposite sides of tracks 213).

The tracks 213 of the cam track assembly 214 may be adapted to facilitate translation of clamp arm 211 along a straight line. Alternatively, the tracks 213 of the cam track assembly 214 can facilitate translation of the clamp arm 211 in two dimensions. In other embodiments, the tracks 213 of the cam track assembly 214 can facilitate translation of clamp arm 211 in three dimensions. In embodiments, tracks 213 of cam track assembly 214 can facilitate rotation of clamp arm 211 about one or more axes. Various combinations or modifications of such embodiments can facilitate degrees of freedom for translation and/or rotation to accommodate various configurations of irregular core 212. In any case, the tracks of the cam track assembly provide a predetermined path for the pinch clamp to travel along. As discussed above, the predetermined path may correspond to a geometric feature or shape of the irregular core.

The cam track assembly 214 can include multiple sets of tracks 213. For example, the cam track assembly 214 can be designed to accommodate multiple configurations and shapes of irregular core 212. Accordingly, multiple sets of tracks 213 can exist within a single cam track assembly 214. In embodiments, the clamp arm 211 and/or pinch clamp 210 can be moved to a different set of tracks 213. In embodiments, there can be more than one clamp arm 211 and/or pinch clamp 210 to facilitate the use of multiple tracks without such switches. In this fashion, more than one irregular core 212 can be accommodated without modifying the system 200 or swapping the cam track assembly 214.

In FIGS. 7A and 7B (and elsewhere herein), the tracks 213 are shown as a set of two paths. However, various other path configurations can be used alternatively to or in combination with the illustrated tracks 213. For example, the tracks 213 can include one path, or three paths. Such examples are not intended to limit the scope of the innovation as described, but merely to suggest aspects not explicitly or exhaustively set forth for purposes of brevity.

As discussed above, embodiments of the system 200 can provide for power to be provided to the cam track assembly 214 and/or clamp arm 211. Alternatively or additionally, the spool 202, guide rollers 205, and/or mandrel rollers 209 may be powered or unpowered and/or passive.

The translation of the pinch clamp 210 can be stopped along the tracks 213 at a desired point or points when the product is applied over all of or a desired portion of the core (e.g., irregular core 212). In specific embodiments, the point or points can be before the “end” (e.g., distal portion in relation to mandrel 206) of tracks 213 or end of the core. After an application is stopped, the braided product can be cut from the source (e.g., spool 202). The braided product can be cut adjacent the mandrel or at any desired location, or at one or more locations. After the braid is applied, the product can be released from the pinch clamp (e.g., pinch clamp 210 releases the product) after stopping along the tracks 213.

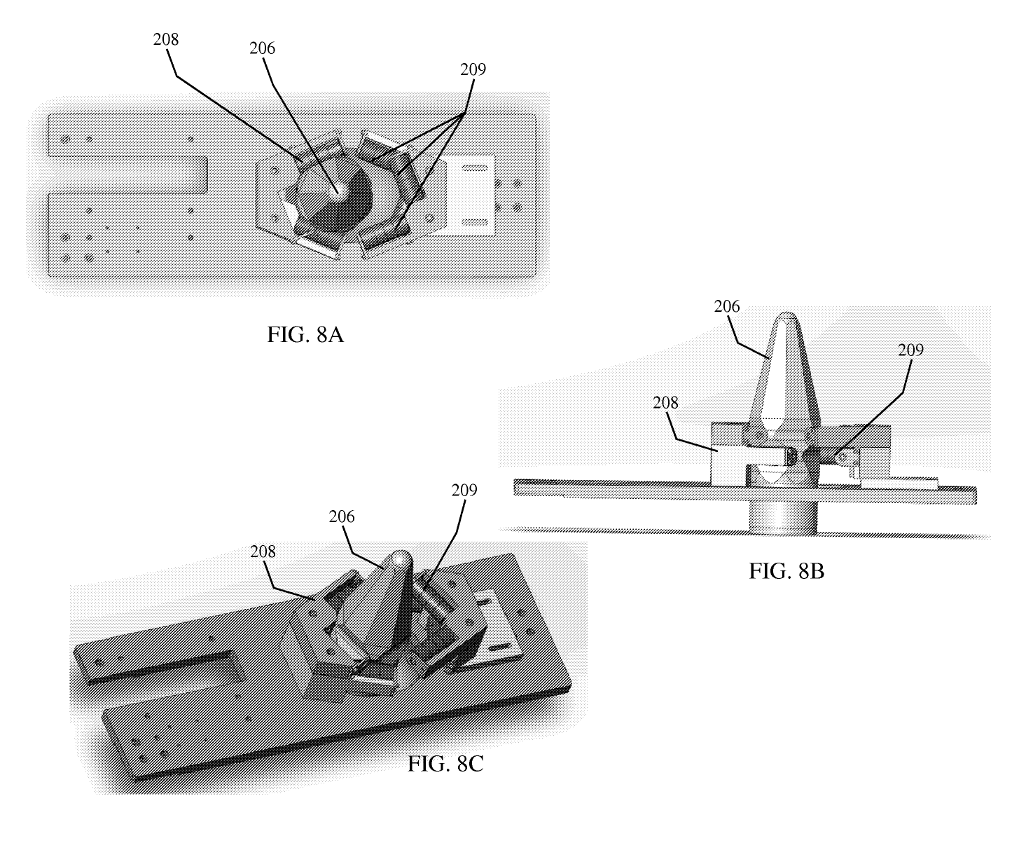

FIGS. 8A, 8B, and 8C show the roller assembly 208 surrounding the mandrel 206, partially as-pictured or wholly (e.g., not pictured in FIG. 8A, 8B, or 8C). As discussed above, the roller assembly 208 include mandrel rollers 209 engaging the suspension portion of the mandrel. While some examples of mandrel rollers 209 are labeled in FIGS. 8A, 8B, and 8C, as well as elsewhere herein, it is appreciated that not every instance of support rollers 209 is labeled in the accompanying figures in the name of simplicity.

As shown in FIGS. 8A, 8B, and 8C, roller assembly 208 symmetrically surround mandrel 206. However, in certain embodiments (e.g., not shown in FIG. 8A, 8B, or 8C), roller assembly 208 can surround mandrel 206 asymmetrically. Various combinations of mandrel rollers 209 supporting mandrel 206 other than those illustrated will be appreciated on review of the disclosures herein. As discussed above, the support rollers 209 do not directly contact the mandrel 206 as the braid passes between the rollers and the mandrel.

The support rollers 209 may be grouped in subsets such as the embodiment shown in FIG. 8. As best shown in FIG. 8B, a first subset of rollers engages the mandrel in an upper plane, and a second subset of rollers engages the mandrel in a lower plane. Focusing on particular aspects, each of rollers 209 has a rotational axis transverse to the direction of travel of the braided product over mandrel 206. As described, this rotational axis can align with a bearing surface (e.g., roller indentations 107 or other recesses) of the mandrel 206. Subsets of rollers 209 and their corresponding rotational axes may be provided in first, second, or additional planes, facilitating additional rollers to contact the mandrel as shown in FIG. 8.

To inhibit deformation of the braid as the braid passes between the mandrel and the rollers, a distance around a perimeter of a cross-section of the braided product remains approximately constant as the braid passes between the mandrel and the rollers. When rollers are provided in multiple planes, such as shown in FIG. 8B, the distance around the perimeter of a cross-section of the sized braided product passing through a first roller plane (e.g., through which one or more rotational axes of one or more of rollers 209 pass) is approximately the same as the distance around the perimeter of the cross-section of the sized braided product passing through a second roller plane (e.g., different from the first plane but still through which one or more rotational axes of one or more of rollers 209 pass). By maintaining the size of the perimeter of the braid through the suspension portion, the mandrel can facilitate maintaining the lengths of tows in the braided article constant while the braided article passes over the mandrel bearing surfaces (e.g., roller indentations 107). The cross-sectional shape of the braided product can be varied over a bearing portion of the mandrel, and a distance around a perimeter of a cross-section of the sized braided product can be maintained approximately the same as the cross-section varies in shape over the bearing portion of the mandrel.

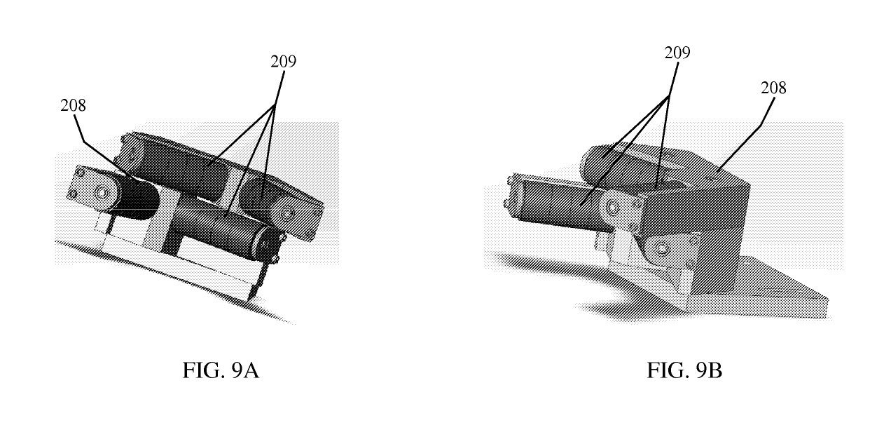

As shown in FIGS. 9A and 9B the roller assembly 208 may include two or more portions that, when mounted opposite one another, at least partially surround mandrel 206. The roller assembly 208 shown in FIGS. 8 and 9 include eight mandrel rollers 209, one roller corresponding to each of the diverging facets 104 discussed above. In other embodiments, different numbers of mandrel rollers 209 can be utilized without departing from the scope or spirit of aspects herein (e.g., a number of mandrel rollers 209 to accord with a different number of sides to at least a portion of the mandrel 206).

While aspects herein have generally depicted application of a braided product to an irregular core as occurring from top to bottom (e.g., spool 202 at the top of frame 216, irregular core downward there from), it is to be appreciated that application can occur on any plane or in any direction. For example, the braided product may be applied (e.g., with reference to a floor or ground being in a downward direction) from bottom-to-top, left-to-right, et cetera.

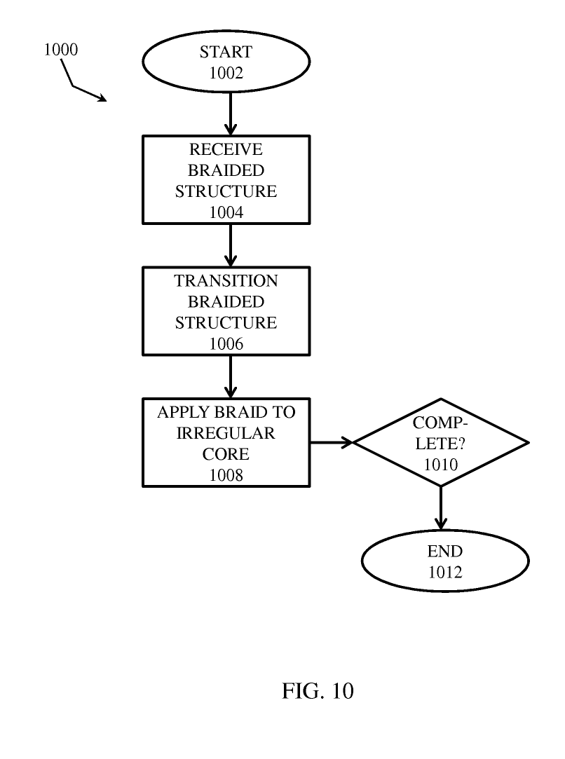

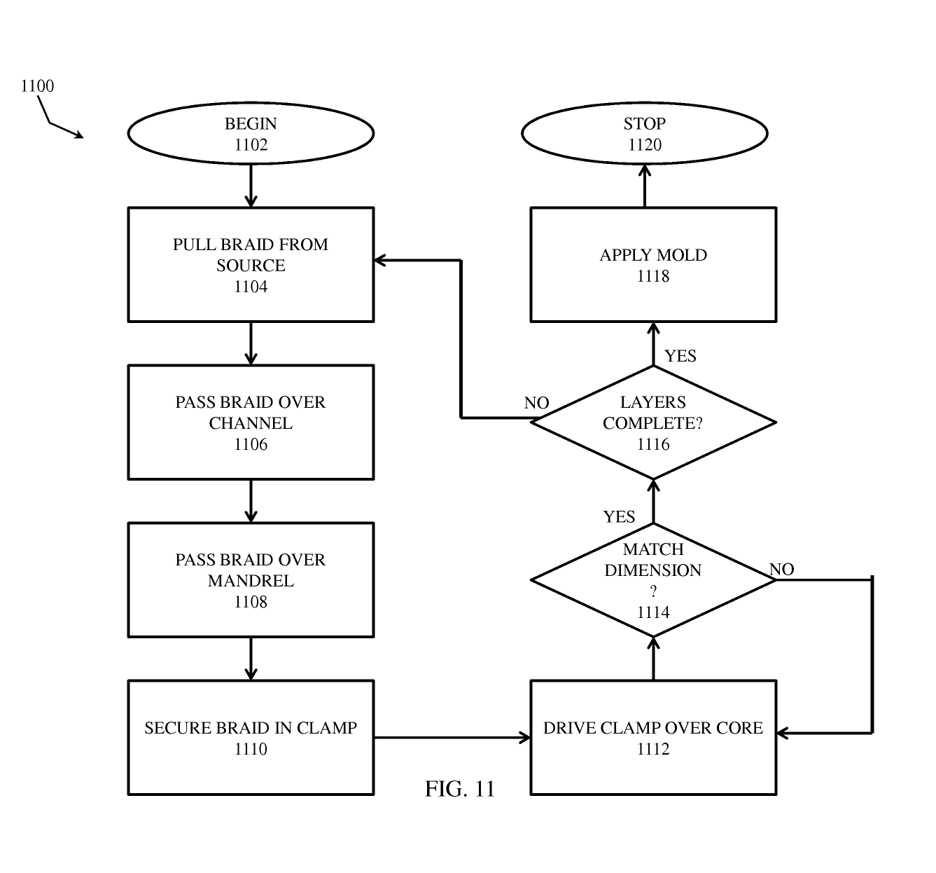

FIG. 10 generally illustrates a flowchart of an example methodology 1000 for applying a braid to an irregular core. While, for purposes of simplicity of explanation, the one or more methodologies shown herein, e.g., in the form of a flow chart, are shown and described as a series of acts, it is to be understood and appreciated that the subject innovation is not limited by the order of acts in FIG. 10 or 11, as some acts may, in accordance with the innovation, occur in a different order and/or concurrently with other acts from that shown and described herein.

Methodology 1000 begins at 1002 and proceeds to receive a braided structure at 1004. Reception of the braided structure can include, for example, the braided structure (e.g., tubular braided product) coming into contact with a guide that facilitates movement of the braided structure through the workflow.

At 1006, the braided structure is transitioned in preparation for application of the braided structure to the irregular core. For example, at 1006, the braided structure can come into contact with or be pulled over a mandrel and/or over or through various rollers. The mandrel and/or rollers can constrain the space through which the braided structure travels and cause the braided structure to be shaped according to such physical constraints. In an embodiment, at least a portion of the components facilitating the transition at 1006 can be formed such that the tows of the braided structure have the same length and/or stresses in all directions. In specific embodiments, at least a portion of one or more developable surfaces can be employed. Accordingly, transitioning can be accomplished at 1006 that inhibits deformation of the braided structure in anticipation of its application to an irregular core.

In embodiments, transitioning the braided structure at 1006 can include clamping or otherwise securing the braided structure to a component that conveys and/or manipulates the braided structure. For example, a clamp can attach to the braid at a portion of the workflow after movement over a mandrel, the clamp being adapted to pull the braided structure through the workflow. By placing the present mandrel between the clamp and the braided structure's source, deformation of the braid is inhibited.

At 1008, the braided structure can be applied to the irregular core. Application to a core can include pulling the braided structure over the core, or otherwise arranging the braided structure about the core. In embodiments, application can include one or more actions to shape the braided structure to the core. In embodiments, multiple layers of braided structure can be applied to a single core. For example, once a dimension of the core has been matched by an amount of braided structure applied, the braided structure can be cut, folded, et cetera, to prepare the braided structure for another layer of application. Various embodiments can further include optional finishing treatments related to application of the braided structure. For example, application of fluid and/or adhesive, heating, cooling, et cetera, can be effected to finalize applications.

The clamp can be used to apply the braided structure to the core at 1008. For example, the clamp can secure at least a portion of the braided structure to pull over the core. In embodiments, the clamp can entirely surround the core. In alternative embodiments, the clamp does not entirely surround the core.

At 1010, a determination is made whether application of the braided structure to the irregular core is complete. If the process is not complete (e.g., additional portions of the irregular core to which additional braided structure can be applied, additional layers of braided structure to apply), methodology 1000 can return to 1004 where additional braided structure is received for application. If the process is determined to be complete at 1010, methodology 1000 proceeds to 1012 and ends.

FIG. 11 generally illustrates a flowchart of an example methodology 1100 for applying a braided composite to an irregular core of at least one known dimension. Methodology 1100 begins at 1102 and can proceed to pull a braided composite from a source at 1104. While a spool is discussed generally in reference to a source for purposes of simplicity, the source can be any source of a braided material, including a braiding machine. The spool can be built into a larger system, or can be a source of braided composite that is attached or supplied but not an integral component of the system. In embodiments, the spool can be powered or unpowered.

At 1106, the braided composite can be passed through a guide. In embodiments, the guide can include one or more of a channel or rollers. Various geometries and/or pluralities of each can be utilized without departing from the spirit or scope of the disclosures herein. The guide(s) can direct the braided composite toward a mandrel.

At 1108, the braided composite can be passed over a mandrel. In embodiments, the braided composite passes between the mandrel and one or more rollers in contact with or near the mandrel. In particular embodiments, a surface of the mandrel can include one or more indentations that interface with one or more rollers, and the rollers can support the mandrel. In embodiments, prior to 1108, the irregular core can be attached to at least a portion of the mandrel.

At 1110, the braided composite can be secured in a clamp. In embodiments, the clamp can surround the irregular core. The clamp can be attached or operatively coupled with at least a cam track, and the clamp can travel at least an amount greater than or equal to a dimension of the irregular core. In embodiments, different configurations of the clamp can be utilized, or the clamp can be exchanged, to accommodate a variety of irregular cores.

Thereafter at 1112 the clamp securing the braided structure can be driven applying the braid over the irregular core. The clamp moves along the core a specified distance according to a specified dimension or distance to apply the braid over the desired portion of the core. The clamp carrying the braided composite can be driven by a power source coupled with the cam track or an arm that links the clamp and the cam track.

Once the braided structure is driven over the irregular core, a determination can be made whether the braid was applied over the specified portion of the core for the braided structure applied at 1114. For example, the braid may be applied to the entire core, or may be applied over a desired portion less than the entire core. If the braid is not applied over the specified location on the core, methodology 1100 can return to 1112 or another portion of methodology 1100 to complete the layer.

If a dimension of the core is matched (e.g., amount of braided composite applied greater than or equal to the dimension of the core), the layer can be complete, and methodology 1100 can proceed to 1116. At 1116, a determination is made whether all layers are complete. If additional braid is desired to be applied to provide an additional layer over the core or to provide braid in another location on the core, methodology 1100 can return to 1104 or another portion of methodology 1100 to apply all layers before proceeding. If all layers are complete, methodology 1100 can proceed to 1118.

At 1118, optionally, a final treatment can be applied to complete application of the braided composite to the core. For example, various molds, liquids, adhesives, heating, cooling, et cetera can be applied to the core with one or more layers of braided composite applied. In embodiments, a treatment or curing can be applied between layers of the braided composite.

Thereafter, methodology 1100 can end at 1120. Methodology 1100 can repeat for multiple applications to identical or similar cores. In embodiments, aspects such as a frame, clamp, or tracks can be modified or exchanged to accommodate additional cores of varying geometry.

While aspects described above include principles of the innovation in connection with one or more specific embodiments, it is to be clearly understood that this description is made only by way of example and not as a limitation of the scope of the invention. Further, although the present invention has been described above in detail, the same is by way of illustration and example only and is not to be taken as a limitation on the present innovation. Accordingly, the scope and content of the present innovation are to be defined only by the terms of the appended claims.

What is claimed is:

1. A method for applying a braided product to an irregular-shaped core, comprising:
receiving the braided product from a source;
sizing the braided product over a mandrel positioned between the source and the irregular core;
securing the braided product to a clamp at least partially surrounding the irregular core; and
moving the clamp along a predetermined path applying the braided product over the irregular core, the path corresponding to a geometric aspect of the irregular core.

2. The method of claim 1, further comprising
suspending the mandrel by a plurality of positioned rollers supporting corresponding bearing surfaces of the mandrel, and
passing the braided product between the bearing surfaces and one or more of the plurality of positioned rollers.

3. The method of claim 2, where each positioned roller has a rotational axis transverse to a direction of travel of the braided product over the mandrel, and each bearing surface forms a recess in an outer surface of the mandrel, the recess being along the rotational axis of a corresponding positioned roller among the plurality of positioned rollers.

4. The method of claim 3, where the rotational axes of the positioned rollers are in one plane transverse to the direction of travel of the braided product over the mandrel.

5. The method of claim 3, where the rotational axes of a first subset of the positioned rollers are in a first plane and the rotational axes of a second subset of the positioned rollers are in a second plane, the first and second planes being transverse to the direction of travel of the braided product over the mandrel.

6. The method of claim 5, further comprising
maintaining a distance around a perimeter of a cross-section of the braided product passing through the first plane to be the same as the distance around the perimeter of the cross-section of the sized braided product passing through the second plane.

7. The method of claim 2, further comprising
maintaining a plurality of lengths of a plurality of tows in the braided product constant while the braided product passes over the bearing surfaces.

8. The method of claim 1, further comprising
varying a cross-sectional shape of the braided product over a bearing portion of the mandrel, and
maintaining a distance around a perimeter of a cross-section of the braided product approximately the same as the cross-section varies in shape over the bearing portion of the mandrel.

9. The method of claim 1, further comprising
suspending the mandrel by one or more positioned rollers supporting one or more corresponding bearing surfaces of the mandrel, the braided product passing between at least one of the bearing surfaces and a corresponding roller among the one or more positioned rollers,
varying the cross-sectional shape of the braided product over the bearing surfaces of the mandrel, and
maintaining a distance around a perimeter of a cross-section of the braided product approximately the same as the cross-section varies in shape over the bearing surfaces of the mandrel.

10. The method of claim 1, stopping the clamp along the path when the braided product is applied to a desired portion of the irregular core.

11. The method of claim 10, further comprising cutting the braided product from the source.

12. The method of claim 10, further comprising:
releasing the clamp and returning the clamp to a start of the path; and
securing another length of the braided product to the clamp.

13. The method of claim 1, further comprising connecting the irregular core to the mandrel.

14. The method of claim 1, wherein conveying the clamp along the path includes rotating the clamp about at least one axis.

15. The method of claim 1, wherein the step of receiving the braided product from the source comprises providing a continuous tubular braided product.

16. An apparatus for applying a prefabricated braided product from a source to an irregular core, comprising:
a mandrel positioned between the source and the irregular core having a perimeter corresponding to a desired size of the prefabricated braided product;
a cam track along a path corresponding to a geometric aspect of the irregular core, and
a clamp movable along the cam track operatively securable to a portion of the prefabricated braided product at least partially surrounding the irregular core.

17. The apparatus of claim 16, where the mandrel is suspended by a plurality of positioned rollers supporting corresponding bearing surfaces of the mandrel, and the mandrel and positioned rollers are adapted to receive the prefabricated braided product between the mandrel bearing surfaces and the roller.

18. The apparatus of claim 17, where each positioned roller among the plurality of positioned rollers has a rotational axis transverse to a direction of travel of the prefabricated braided product over the mandrel, and each bearing surface forms a recess in an outer surface of the mandrel, the recess being along the rotational axis of a corresponding positioned roller among the plurality of positioned rollers.

19. The apparatus of claim 18, where the rotational axes of the positioned rollers are in one plane transverse to the direction of travel of the prefabricated braided product over the mandrel.

20. The apparatus of claim 18, where the rotational axes of a first subset of the positioned rollers are in a first plane and the rotational axes of a second subset of the positioned rollers are in a second plane, the first and second planes being transverse to the direction of travel of the prefabricated braided product over the mandrel.

21. The apparatus of claim 20, further comprising
a distance around a perimeter of a cross-section of the mandrel through the first plane is the same as the distance around the perimeter of the cross-section of the mandrel through the second plane.

22. The apparatus of claim 16, further comprising
the mandrel having a bearing portion having varying cross-sectional shapes over the bearing portion,
where a distance around a perimeter of a cross-section of the mandrel is approximately the same as the cross-section varies in shape over the bearing portion of the mandrel.

23. The apparatus of claim 16, further comprising
where the mandrel is suspended by a plurality of positioned rollers supporting corresponding bearing surfaces of the mandrel, and the mandrel and positioned rollers are adapted to receive the prefabricated braided product between the bearing surfaces and the roller,
the mandrel having a bearing portion having varying cross-sectional shapes over the bearing surfaces,
where a distance around a perimeter of a cross-section of the mandrel is approximately the same as the cross-section varies in shape over the bearing surfaces of the mandrel.

24. The apparatus of claim 16, wherein the mandrel is connected to the irregular core.

25. A mandrel for resizing a braided article comprising:
a bearing portion having varying cross-sectional shapes over the bearing portion,
the varying cross-sectional shapes adapted to maintain a plurality of lengths of tows in the braided article constant while the braided article passes over the mandrel bearing portion.

26. The mandrel of claim 25, where a distance around a perimeter of a cross-section of the mandrel is approximately the same as the cross-section varies in shape over the bearing portion of the mandrel.
